(19) United States
(12) Patent Application Publication
(10) Pub. No.: US 2008/0068714 A1
(43) Pub. Date: Mar. 20, 2008

(54) STACKABLE HEMISPHERIC LIGHT REFLECTING BEACON

(76) Inventor: Gilles Ruest, Gatineau (CA)

Correspondence Address: INVENTARIUM, 4050 Rosemont blvd #1607, Montreal, QC, H1X 1M4, US

(21) Appl. No.: 11/551,219

(22) Filed: Oct. 19, 2006

(30) Foreign Application Priority Data
Sep. 19, 2006 (CA) CA 2561692

(51) Int. Cl. G02B 5/12

(52) U.S. Cl. 359/549

(57) ABSTRACT

A stackable hemispheric reflective beacon has a hollow dome with an inner and an outer surface and the outer surface is covered with a light reflective coating. Any light from a light source that is shone on the hollow dome along a vertical plane from 0 to 180 degrees and 360 degrees along a horizontal plane is reflected back at the light source.

### FIELD OF THE INVENTION

The present invention relates to beacon systems. More specifically, the present invention is concerned with a light reflecting beacon device shaped like a hemisphere and visible from an in flight airplane, the ground or from the water on a boat.

### BACKGROUND OF THE INVENTION

There is often a need to light up a temporary runway for use by bush pilots who pretty much use any flat surface to land an airplane. During daytime, there is no need for marking the runway but at night, lighting is important. In remote regions or developing countries, drums filled with flammable material are lined up to mark both sides of the runway. This is of course very time consuming and not very practical for many reasons. Some inventors have used reflective material to coat surfaces that they use as beacons. Most of those devices do not offer reflectivity in all angles and are merely used to aid in take off to mark a path for the airplane as they are invisible to aiborne planes. In recent years, some inventors like U.S. Pat. No. 6,514,006 and US design patent D379436 show reflective beacons having shapes that allow for high reflectivity across a wide range of angles.

Although the reflectivity issue has been solved in the prior art, there are other factors of practicability that the prior art has yet to resolve.

### Prior Art Capability and Motivations, as Helping to Show Patentability Here

Even in hindsight consideration of the present invention to determine its inventive and novel nature, it is not only conceded but emphasized that the prior art had many details usable in this invention, but only if the prior art had had the guidance of the present invention, details of both capability and motivation.

That is, it is emphasized that the prior art had/or knew several particulars which individually and accumulatively show the non-obviousness of this combination invention. E.g.,

a) knowledge of highly reflective material;
b) knowledge of angles of reflection;
c) knowledge of remote regions requirements;
d) The nature of an invention as being a “novel combination”, in spite of existence of details separately, is especially significant here where the novelty is of the plurality of concepts, i.e., the use of highly reflective material with the use of a rounded shape to allow reflectivity along all angles, stackability, and means for securing each beacon in place;
e) The ease of tooling for the present invention has surely given manufacturers ample incentive to have made modifications for commercial competitiveness in a competitive industry, if the concepts had been obvious;
f) The prior art has always had sufficient skill to make to have achieved the present invention, but only if the concepts and their combinations had been conceived;
g) Substantially all of the operational characteristics and advantages of details of the present invention, when considered separately from one another and when considered separately from the present invention's details and accomplishment of the details, are within the skill of persons of various arts, but only when considered away from the integrated and novel combination of concepts which by their cooperative combination achieve this advantageous invention;
h) The details of the present invention, when considered solely from the standpoint of construction, are exceedingly simple, basically a molded piece of material (metal or plastics) covered with readily available reflective material (usually from 3M corporation) and the matter of simplicity of construction has long been recognized as indicative of inventive creativity;
i) Similarly, and a long-recognized indication of inventiveness of a novel combination, is the realistic principle that a person of ordinary skill in the art, as illustrated with respect to the claimed combination as differing in the stated respects from the prior art both as to construction and concept, is presumed to be one who thinks along the line of conventional wisdom in the art and is not one who undertakes to innovate; and
j) The predictable benefits from a novel tile product and installation method having the features of this invention would seem sufficiently high that others would have been working on this type of product, but only if the concepts which it presents had been conceived.

Accordingly, although the prior art has had capability and motivation, amply sufficient to presumably give incentive to the development of a product and installation method according to the present invention, the fact remains that this invention awaited the creativity and inventive discovery of the present Inventor. In spite of ample motivation, the prior art did not suggest this invention.

### Prior Art as Particular Instances of Failure to Provide This Novel Product and Installation Method

In view of the general practical advantage of the economy of space required for storage or for transportation from location to location that the present invention offers as an improved embodiment of the prior art, it may be difficult to realize that the prior art has not conceived of the combination purpose and achievement of the present invention, even though the need for such a simple to manufacture, lightweight and convenient product is a known requested commodity which prompted the request for a patent since investors who have looked long and hard at all of the prior art have not showed any interest in the lack of practicability of the other products but have shown great interest in this product which solves many practical problems in the field which were not solved by any of the prior art. Surely many have seen the lack of practicability of the prior art has been known for years and that the various combination provided in this invention would have been desired and attempted long ago, but only if its factors and combination-nature had been obvious.

Other considerations, as herein mentioned, when realistically evaluated show the inventive nature of the present invention, a change in concept which the prior patent and other prior art did not achieve.

### Summary of the Prior Art'S Lack of Suggestions of the Concepts of the Invention'S Combination

And the existence of such prior art knowledge and related ideas embodying such various features is not only conceded, it is emphasized; for as to the novelty here of the combination, of the invention as considered as a whole, a contrast to the prior art helps also to remind of needed improvement, and the advantages and the inventive significance of the present concepts. Thus, as shown herein as a contrast to all the prior art, the inventive significance of the present concepts as a combination is emphasized, and the nature of the concepts and their results can perhaps be easier seen as an invention.

Although varieties of prior art are conceded, and ample motivation is shown, and full capability in the prior art is conceded, no prior art shows or suggests details of the overall combination of the present invention, as is the proper and accepted way of considering the inventiveness nature of the concepts.

That is, although the prior art may show an approach to the overall invention, it is determinatively significant that none of the prior art shows the novel and advantageous concepts in combination, which provides the merits of this invention, even though certain details are shown separately from this accomplishment as a combination.

And the prior art's lack of an invention of an economical, easy to install reflective beacon achieving a practical and effective result of the present invention, which are goals only approached by the prior art, must be recognized as being a long-felt need now fulfilled.

Accordingly, the various concepts and components are conceded and emphasized to have been widely known in the prior art as to various installations; nevertheless, the prior art not having had the particular combination of concepts and details as here presented and shown in novel combination different from the prior art and its suggestions, even only a fair amount of realistic humility, to avoid consideration of this invention improperly by hindsight, requires the concepts and achievements here to be realistically viewed as a novel combination, inventive in nature. And especially is this a realistic consideration when viewed from the position of a person of ordinary skill in this art at the time of this invention, and without trying to reconstruct this invention from the prior art without use of hindsight toward particulars not suggested by the prior art.

### SUMMARY OF THE INVENTION

In view of the foregoing disadvantages inherent in the known devices now present in the prior art, the present invention, which will be described subsequently in greater detail, is to provide objects and advantages which are:

To provide for a stackable hemispheric reflective beacon that can be installed in place relatively quickly.

To provide for a stackable hemispheric reflective beacon that can be disassembled and taken away relatively quickly.

To provide for a stackable hemispheric reflective beacon that is clearly and easily visible from the air several kilometers away at night or day.

To provide for a stackable hemispheric reflective beacon that is clearly and easily visible from the ground or at water level at night or day.

To attain these ends, the stackable hemispheric reflective beacon has a hollow dome with an inner and an outer surface and the outer surface is covered with a light reflective coating. Any light from a light source that is shone on the hollow dome along a vertical plane from 0 to 180 degrees and 360 degrees along a horizontal plane is reflected back at the light source.

The invention is further comprised of a base that extends integrally from the dome to form tabs. The tabs have holes designed to allow for stakes to be planted therethrough.

In the context of an airstrip, the stackable hemispheric reflective beacons are installed in the following method:

An airstrip is marked by the plurality of stackable hemispheric reflective beacons laid down along two parallel rectilinear paths. Each of those rectilinear path are spaced apart at a distance that is in relation to the type of planes for which the airstrip is designed for and along each given rectilinear path are spaced apart at regular intervals one of the hemispheric reflective beacon. The hemispheric reflective beacon can also be secured in place using stakes planted into the ground using holes made through the base of the hemispheric reflective beacon.

There has thus been outlined, rather broadly, the more important features of the invention in order that the detailed description thereof that follows may be better understood, and in order that the present contribution to the art may be better appreciated. There are additional features of the invention that will be described hereinafter and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. For example, although primarily directed at the markings or airstrips, it should be understood that the invention can be used to mark a variety of things such as perimeters or dividing lines such as borders and other such geographic locations. It can be used by hikers as distress or locating device. The device can also reflect sunlight during daytime and be visible somewhat like using mirrors. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

These together with other objects of the invention, along with the various features of novelty which characterize the invention, are pointed out with particularity in the claims annexed to and forming a part of this disclosure. For a better understanding of the invention, its operating advantages and the specific objects attained by its uses, reference should be made to the accompanying drawings and descriptive matter which contains illustrated preferred embodiments of the invention.

### BRIEF DESCRIPTION OF THE DRAWINGS

FIG. 1 is a perspective view of hemispheric reflecting beacons as laid out to mark a runway.

FIG. 2 is a perspective view of a single hemispheric reflecting beacon.

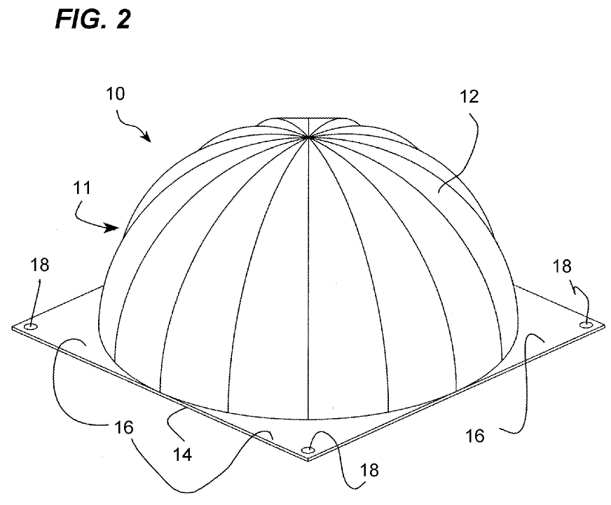

FIG. 3 is a cross cut side view of two hemispheric reflecting beacon being stacked.

### DETAILED DESCRIPTION

A stackable hemispheric reflective beacon (10) has a hollow dome (11) having an inner surface (13) defining a hollow volume (17) and an outer surface (15). The outer surface (15) is covered with a light reflective coating (12). Light shone on the light reflective coating (12) will be reflected back at the light source. So, any light from a light source that is shone on the hollow dome (11) along a vertical plane from 0 to 180 degrees and 360 degrees along a horizontal plane will be reflected back at the light source. The light reflective coating (12) is of the type manufactured by 3M corporation (or equivalent product manufactured by any company for that matter) and which is well known in various fields of industry such as highway signs, clothing, entertainment industry and other industries. The light reflective coating (12) can be applied during the manufacturing process of the a stackable hemispheric reflective beacon (10) or applied later as a spray, or painted on, or applied adhesively as a thin film. Since the methods of application are already known in various industries, they will not be further discussed here.

The stackable hemispheric reflective beacon (10) can be made by any of a variety of manufacturing methods such as injection moulding, roto-moulding, or vacu-forming, if made out of plastics and by casting or stamping if made out of metal. Sintering could be yet another manufacturing method.

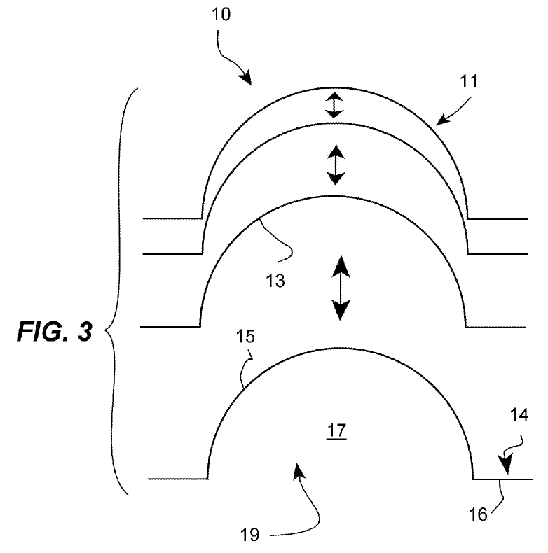

Whatever the manufacturing method which are all known manufacturing methods, the desired end result is that of a hollow dome structure which can be stackable as per FIG. 3 because the nature of a dome allows that feature.

The stackable hemispheric reflective beacon (10) has a base (14) which is so shaped as to provide tabs (16) which extends integrally from the hollow dome (11). These tabs (16) not only provide for a large flat base upon which to rest but also a location for holes (18) which are designed to allow for stakes (not shown) to be planted in the ground in order to secure the stackable hemispheric reflective beacon (10) in place so that wind or other factors cannot move it. By planting stakes to secure the stackable hemispheric reflective beacon (10) instead of having to hammer directly on the device as is the case in some of the prior art, the reflective coating is not damaged or kinked in any way so as to reduce the reflective characteristics of the device. Although shown in the figures as being substantially square with four tabs (16), it should be understood that the base can be of any polygonal shape or even a flat disc and still fall within the scope of the invention. Also, the dome can be oval in shape (along a vertical or horizontal plane or both) or shaped like a semi buckyball or any geometric shape that still provide efficient stacking feature and still fall within the scope of the invention.

Being stackable and made with relatively lightweight material and being of a reasonable size, each stackable hemispheric reflective beacon (10) is sufficiently light and, as a stacked bundle, does not occupy a lot of space which allows for easy transportation by ground crew or even on a plane which could carry its own airstrip lighting system, providing of course that the plane lands at least once in daytime so as to have the time afterwards to position the beacons at the landing location for night use.

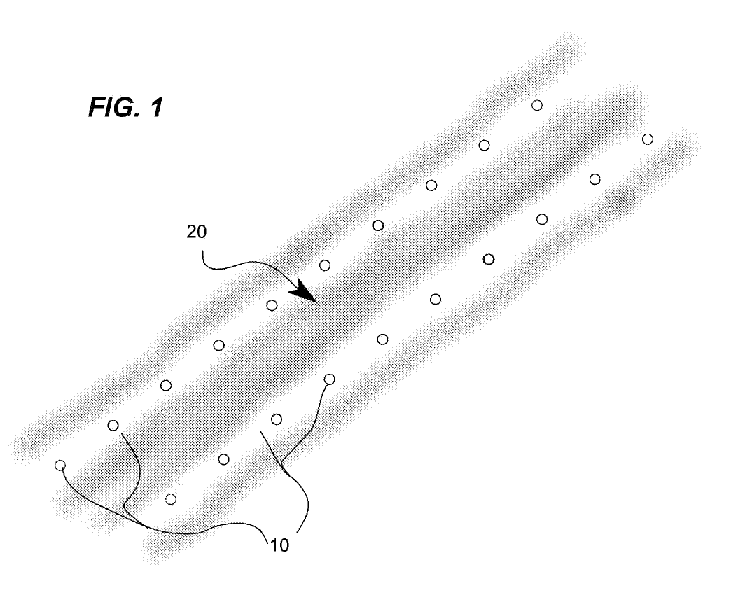

FIG. 1 shows a proposed line up of stackable hemispheric reflective beacons (10) which are spaced apart at regularly spaced intervals much as electric runway lights are currently positioned.

Different diameters of stackable hemispheric reflective beacon (10) could be manufactured according to needs.

Although the primary usage of this invention is for marking ground airstrip (20), the hemispheric reflective beacon (10) can also be used on water for guiding hydroplanes or boats. Indeed, their holes can be used for passing ropes or cables so that strips of floating hemispheric reflective beacon (10) can mark a path. To further insure reliable buoyancy of the hemispheric reflective beacon (10), the opened bottom (19) can be closed in by a plate (not shown) which seals the hollow volume (17) to prevent ingress of water. The plate can be mechanically fastened by passing mechanical fasteners through the holes (18) and having the plates hold the ropes or cables.

As to a further discussion of the manner of usage and operation of the present invention, the same should be apparent from the above description. Accordingly, no further discussion relating to the manner of usage and operation will be provided.

With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

1. A stackable hemispheric reflective beacon comprising:
a hollow dome;
said hollow dome having an inner and an outer surface;
said outer surface being covered with a light reflective coating.

2. A stackable hemispheric reflective beacon as in claim 1 wherein:
any light from a light source that is shone on said hollow dome along a vertical plane from 0 to 180 degrees and 360 degrees along a horizontal plane is reflected back at said light source.

3. A stackable hemispheric reflective beacon as in claim 1 wherein:
a base extending integrally from said dome to form tabs.

4. A stackable hemispheric reflective beacon as in claim 3 wherein:
said tabs having holes designed to allow for stakes to be planted therethrough.

5. A stackable hemispheric reflective beacon comprising:
a hollow dome;
said hollow dome having an inner and an outer surface;
said outer surface being covered with a light reflective coating;
a base extending integrally from said dome to form tabs;
said tabs having holes designed to allow for stakes to be planted therethrough.

6. A stackable hemispheric reflective beacon as in claim 1 having the following method of installation:
an airstrip is being marked by said plurality of stackable hemispheric reflective beacons laid down along two parallel rectilinear paths;
each said rectilinear path being spaced apart at a distance that is in relation to the type of planes for which said air strip is designed for;
along each given said rectilinear path are spaced apart at regular intervals one said hemispheric reflective beacon.

7. A stackable hemispheric reflective beacon as in claim 4 having the following method of installation:
an airstrip is being marked by said plurality of stackable hemispheric reflective beacons laid down along two parallel rectilinear paths;
each said rectilinear path being spaced apart at a distance that is in relation to the type of planes for which said airstrip is designed for;
along each given said rectilinear path are spaced apart at regular intervals one said hemispheric reflective beacon;
each said hemispheric reflective beacon is fixed in place by stakes planted through said holes.
